(19) United States
(12) Patent Application Publication
(10) Pub. No.: US 2016/0040705 A1
(43) Pub. Date: Feb. 11, 2016

(54) CONNECTING ELEMENT AND CONNECTING ARRANGEMENT

(71) Applicant: BROSE FAHRZEUGTEILE GMBH & CO. KOMMANDITGESELLSCHAFT, HALLSTADT, HALLSTADT (DE)

(72) Inventors: BENJAMIN DANIEL PETER, COBURG (DE); KLAUS HAMPEL, COBURG (DE); CARSTEN HAERING, AHORN (DE)

(21) Appl. No.: 14/886,318

(22) Filed: Oct. 19, 2015

Related U.S. Application Data
(63) Continuation of application No. PCT/EP2014/001039, filed on Apr. 17, 2014.

(30) Foreign Application Priority Data
Apr. 19, 2013 (DE) 102013006720.0

(51) Int. Cl. F16B 21/02

(52) U.S. Cl. CPC F16B 21/02

(57) ABSTRACT

A connecting element for mechanically connecting at least two components of a motor vehicle has a bearing collar for bearing against a first component and a transverse latch which contains a clamping wedge for clamping the second component against the first component in a twisted final mounted position. The connecting element further having a shaft section which bears the transverse latch and is intended to be twistably guided through corresponding openings in the first component and in the second component. According the clamping wedge has a planar slide configured to be in linear bearing contact with the edge of the opening in the second component at least over part of the twisting movement into the final mounted position.

### CROSS-REFERENCE TO RELATED APPLICATION

This is a continuation application, under 35 U.S.C. §120, of copending international application No. PCT/EP2014/001039, filed Apr. 17, 2014, which designated the United States; this application also claims the priority, under 35 U.S.C. §119, of German patent application No. DE 10 2013 006 720.0, filed Apr. 19, 2013; the prior applications are herewith incorporated by reference in their entirety.

### BACKGROUND OF THE INVENTION

### Field of the Invention

The present invention relates to a connecting element for the mechanical connection of at least two components of a motor vehicle, in particular two components of a motor vehicle door. The connecting element has an abutment collar for abutment against a first component, a transverse bar which substantially extends in a longitudinal direction and which contains at least one clamping wedge for clamping the second component against the first component in a rotated final assembly position, and a shaft portion which carries the transverse bar for being rotatably introduced through corresponding openings in the first component and in the second component. The invention further relates to a connecting arrangement containing at least a first component of a motor vehicle and a second component of a motor vehicle which have mutually corresponding openings, and an above-mentioned connecting element, wherein, in order to produce the connection in a final assembly position, the connecting element can be rotated from an angular insertion position into an angular end position, in which the connecting element engages through the corresponding openings of the first component and the second component.

A connecting element of the above-mentioned type is used in particular in order to mechanically connect a motor vehicle internal door plate to a unit carrier (also called a module carrier), in order to connect the unit carrier to a decorative carrier shell or to connect all three components. In this instance, at least two plate-like components are connected to each other by a rapid-fit closure so that, for example, the subassemblies of a motor vehicle door can be assembled on each other rapidly and with few hand operations in a simple manner.

International patent disclosure WO 2008/101531 A1, corresponding to U.S. patent publication No. 2009/0045173, discloses a connecting element and a connecting arrangement of the type mentioned in the introduction. The connecting element described therein is located in a supply state in a pre-assembly position engaged in the opening of the first component which is mounted, for example, on a unit carrier in a rotationally secure manner. In the pre-assembly position, the transverse bar of the connecting element is received in the opening of the first component so that the fitting of the unit carrier or the assembly thereof on an internal door plate is not impeded unnecessarily by projecting components. In order to secure the two components, that is to say, in particular the unit carrier and the internal door plate, the connecting element is rotated from the angular insertion position thereof in the pre-assembly position with axial offset into an angular end position of a final assembly position. In this instance, the transverse bar of the connecting element engages through a corresponding opening in the second component, wherein the clamping wedge clamps the second component with the first component at the abutment collar of the connecting element as a result of a subsequent rotation in the manner of a bayonet-like closure.

In order to inwardly rotate the known connecting element, a substantial axial pressure has to be disadvantageously applied, whereby there is the risk of deformation of the components to be connected. If the axial offset of the connecting element is brought about on the other hand by inward rotation of the clamping wedge under the second component, an undesirably high torque has to be applied for the rotational movement.

### SUMMARY OF THE INVENTION

Therefore, an object of the invention is to provide a connecting element of the type mentioned in the introduction which is further improved with regard to the assembly thereof. In particular, the final assembly position of the connecting arrangement is intended to be able to be reached in an even easier and simpler manner with respect to the prior art.

The object of the invention is achieved in a first variant according to the invention by a connecting element of the type mentioned in the introduction, wherein the clamping wedge contains a planar sliding path which is constructed to form a linear abutment against the edge of the opening in the second component at least over a partial range of the rotational movement into the final assembly position.

The invention is based in this instance in a first step on the recognition obtained by independent observations that the stiffness during the inward rotation of the clamping wedge of a connecting element according to the prior art results from the fact that the clamping wedge touches the comparatively sharp-edged edge at the opening of the second component in a substantially point-like manner. During inward rotation, consequently, there is produced turning of the edges, abrasion or drawing of shavings at the contact location, whereby the undesirably high torque is explained.

In a second step, the invention takes as a basis the consideration that this problem can be solved if the contact location of the clamping wedge with respect to the edge at the opening of the second component is increased. To this end, there is provided on the clamping wedge of the connecting element a planar sliding path which is constructed to form a linear abutment against the edge of the opening in the second component at least over a partial range of the rotational movement into the final assembly position. The sliding path forms a contact face, along which the edge of the opening moves during the inward rotation of the connecting element. As a result of the planarity of the sliding path, a point-like contact location is no longer provided but instead a linear abutment against the edge of the opening is obtained. Consequently, the pressure which acts on the contact location during inward rotation is reduced. The connecting element can be rotated inward under the second component with the clamping wedge along the sliding path more readily. Any effects involving shavings or turning of edges are avoided or at least substantially reduced. In particular, the range of plastics materials which can be used is thereby also increased. In comparison with the known prior art, there may also be used for the connecting element which is described herein plastics materials which have a lower hardness or a lower wear-resistance.

In a second variant, the object of the invention is achieved according to the invention by a connecting element of the type mentioned in the introduction, wherein the width of the clamping wedge, which width extends in the rotational plane and is perpendicular to the longitudinal direction of the transverse bar, has a larger dimension than the corresponding thickness of the shaft portion, which thickness is perpendicular to the longitudinal direction of the transverse bar.

The invention is based in this instance in a first step on the consideration that generally an increased travel and in this regard an improved clamping of the motor vehicle components can be achieved as a result of an increase of the clamping wedge for the same gradient and consequently with the same actuation force. In a second step, the invention recognizes that an increase of the clamping wedge is readily possible if the width thereof perpendicular to the transverse bar, that is to say, perpendicularly to the longitudinal direction in which the transverse bar substantially extends, has in the rotational plane a greater dimension than the corresponding thickness of the shaft portion. In order to receive the increased engaging wedge in the radial edge region, although the openings in the two components have to be increased accordingly, there still remains for clamping sufficient surface-area on the components which the clamping wedge can engage behind when the connecting element is rotated into the final assembly position. As a result of the increased clamping wedge, the axial travel of the connecting element necessary for producing the connection can be applied substantially by the rotational movement. The axial force application for pressing in the connecting element during the assembly is thereby reduced. The risk of a deformation of the components to be connected is reduced.

In particular, the object of the invention is also achieved according to the invention by a connecting element, in which the features of the above-mentioned first variant and the above-mentioned second variant are combined with each other. There is accordingly provision for arranging on a widened clamping wedge a planar sliding path which is constructed to form a linear abutment against the edge of the opening of the second component at least over a partial range of the rotational movement into the final assembly position.

In a preferred development, the clamping wedge tapers, where applicable with the planar sliding path, into a finger-like introduction tip. At the other end thereof, the clamping wedge preferably contains an abutment face, into which the planar sliding path merges where applicable. As a result of an introduction tip, on the one hand, the inward rotation of the clamping wedge of the connecting element under the second component from the angular insertion position is improved. On the other hand, however, a finger-like introduction tip also allows an additional increase of the clamping wedge or the sliding face overall. An introduction tip does not provide any substantial contribution to the clamping action. However, it ensures a reliable introduction of the clamping wedge under the opening of the second motor vehicle component.

Preferably, the introduction tip extends with its effective region over an angular range between 5° and 10°. The planar sliding path, which may extend over the clamping wedge including the introduction tip, where applicable, advantageously covers an angular range between 65° and 85°. If the sliding path merges into a planar abutment face, the planar abutment face extends in a further preferable manner over an angular range between 25° and 30°. As a result, the region of the clamping wedge responsible for the clamping, or the sliding face thereof between the introduction tip and the abutment face, advantageously covers an angular range between 60° and 75°. Independent investigations have shown that a high level of clamping of the two motor vehicle components is obtained with those angular ranges or with the given division of the angular ranges over the introduction tip, the sliding path and the abutment face with a comparatively small actuation force by rotation of the connecting element.

In a further preferred embodiment, the clamping wedge extends in a peripheral direction over an angular range between 95° and 115°. In this angular range, a large axial travel of the connecting element can be achieved with a relatively shallow gradient of the clamping wedge without the openings provided in order to introduce the connecting element having to be unnecessarily extended in the region of the clamping wedge. The angular spacing between the angular insertion position and the angular end position of the connecting element is correlated with the given angular range of the clamping wedge.

In an advantageous embodiment, means for pre-positioning the transverse bar in the opening of the first component in a pre-assembly position are further included. As a result, the final assembly of the two components to be connected is substantially simplified because the first component can already be supplied with the connecting element pre-positioned therein.

In an advantageous manner, at least one radially outwardly extending snap-fit tongue which is arranged in the region of the clamping wedge is included as the means for non-releasable receiving of the transverse bar in the opening of the first component. As a result of the radial orientation of the snap-fit tongue, in particular space is provided for the clamping wedge which extends in a peripheral direction without the necessary opening having to be increased. In other words, the snap-fit tongue which is constructed to retain the connecting element in the pre-assembly position corresponds to a partial region at the edge of the respective opening which differs from the partial region of the edge to which the downwardly introduced tip of the clamping wedge corresponds, which tip is “rotated away” from the snap-fit tongue in the peripheral direction. In a particularly preferred manner, the snap-fit tongue extends in a longitudinal direction of the transverse bar.

In order to retain the transverse bar of the connecting element in the opening of the first component, the snap-fit tongue with the free end thereof is preferably angled away in the direction of the abutment collar and is constructed in order to engage behind a first peripheral projection at the edge of the opening of the first component in the pre-assembly position. In order to produce the pre-assembly position, the connecting element is introduced into the opening of the first component until the snap-fit tongue with the free end thereof snap-fits behind the first peripheral projection and then engages behind it. It is no longer possible to withdraw the connecting element counter to the introduction direction without bending back the snap-fit tongue.

In an advantageous manner, alternatively or additionally, there is arranged as the means for positioning the transverse bar in the region of the shaft portion at least one engaging tongue which contains an engagement edge for abutment against a second peripheral projection at the edge of the opening of the first component in the pre-assembly position.

In order to produce the pre-assembly position, the connecting element is introduced into the opening of the first component until the engagement edge of the engaging tongue strikes the second peripheral projection. Without additional application of force, it is no longer possible to push the connecting element further through the opening of the first component.

For final assembly, the connecting element located in the pre-assembly position is preferably displaced further in an axial direction by rotation, wherein the engaging tongue bends backward until the engagement edge slides past the second peripheral projection. In a second advantageous embodiment, the engaging edge is supported on the engaging tongue at the side facing the abutment collar with a wedge-like strut arrangement. Such a wedge-like strut arrangement simultaneously results in an additional force being produced in the forward direction as a result of the restoring force of the engaging tongue when the connecting element is pressed against the edge of the first component.

If the so-called snap-fit tongue is combined with the engaging tongue, the connecting element is secured in the opening of the first component both in the forward and backward direction in the pre-assembly position.

Advantageously, an engaging wedge for engaging in an engaging groove of the first component in the final assembly position is constructed at the rear side of the abutment collar facing the shaft portion. The engaging wedge retains the connecting element in the inwardly rotated final assembly position. Consequently, it is impossible per se to rotate the connecting element back out of the final assembly position. However, the connecting element can again be displaced axially with resilient deformation of the components thereof in order to release the connection, whereby the engaging wedge is lifted out of the engaging groove.

In a preferred embodiment, a seal which contains a flexible sealing lip and a contact lip which is axially recessed relative thereto is arranged at the rear side of the abutment collar facing the shaft portion. The flexible sealing lip seals in the final assembly position the abutment collar of the connecting element against the first component. In other words, the openings in the components are covered in a sealing manner by the abutment collar of the connecting element.

The flexible sealing lip is deformed in a sealing manner during assembly. The axially recessed contact lip compensates for tolerances between the components by the resilience of the sealing material in the final assembly position. As a result of the decoupling of the sealing action and the tolerance compensation, both functionalities can be optimized separately. The contact lip and the flexible sealing lip at the seal are preferably spaced apart from each other by a channel. With the same sealing material, the flexibility of the sealing lip is particularly obtained in that it has a reduced thickness with respect to the contact lip. The seal is further preferably constructed as a peripheral sealing ring, wherein the flexible sealing lip is constructed on the outer periphery and the contact lip is constructed on the inner periphery of the sealing ring.

The object of the invention is further achieved according to the invention by a connecting arrangement of the type mentioned in the introduction, wherein according to a first variant the planar sliding path of the clamping wedge forms a linear abutment with the edge of the opening of the second component at least over a partial range of the rotational movement into the final assembly position.

The object of the invention is further achieved according to the invention by a connecting arrangement of the type mentioned in the introduction, wherein according to a second variant the contour of the opening of the second component is increased in a protrusion in the radial edge region thereof in order to receive the clamping wedge in a rotational direction to the final assembly position, wherein the clear width of the contour in the region of the protrusion has a greater dimension than the clear width of the contour in a central region in order to receive the shaft portion. This preferably also applies accordingly to the contour of the opening of the first component. However, it is not absolutely necessary for the second component to increase the contour only in the edge region in order to introduce the clamping wedge. It may also be envisaged to increase the opening overall because no surface-area is required for a clamping wedge to engage behind. However, it is advantageous to provide on the first component sufficient surface-area for functional elements which are provided, for example, for positioning of the connecting element in a pre-assembly position.

In particular, the object of the invention is also achieved by a connecting arrangement of the type mentioned in the introduction, wherein the features of the above-mentioned first variant and the features of the above-mentioned second variant are combined with each other. Accordingly, the planar sliding path of the clamping wedge forms with the edge of the opening of the second component a linear abutment at least over a partial range of the rotational movement into the final assembly position, wherein the contour of the opening of the second component is increased in a protrusion in the radial edge region thereof in order to receive the clamping wedge in a rotational direction to the final assembly position, wherein the clear width of the contour in the region of the protrusion has a greater dimension than the clear width of the contour in a central region in order to receive the shaft portion.

The linear abutment of the edge of the opening of the second component against the planar sliding path is particularly optimized in that the protrusion of the opening of the second component extends in the rotational fixing direction, which is formed at least in order to receive the region of the tip of the clamping wedge, in particular the introduction tip of the clamping wedge.

The angular range covered by the contour of the opening of the second component in the radial edge region in a peripheral direction is preferably between 95° and 115°. As a result, the widened clamping wedge can be received in the radial edge region of the opening of the second component, wherein there still remains sufficient surface-area for clamping the second component to the first component, which surface-area is engaged behind by the clamping wedge of the connecting element.

In a further advantageous embodiment, there is arranged at the edge of the opening of the first component a recessed ramp for abutment of the engaging wedge at the rear side of the abutment collar of the connecting element at least over a partial range of the rotational movement into the final assembly position. The reaching of the final assembly position is facilitated by this ramp. When the connecting element is rotated inward, the engaging wedge moves into contact with the ramp at the rear side of the abutment collar, whereby the axial pretensioning is further increased during further rotation. An engaging groove is advantageously arranged at the end of the ramp. After the ramp has been travelled over, the engaging wedge moves into the engaging groove, whereby the connecting arrangement is produced with a defined pretensioning.

The ramp is advantageously arranged on the second peripheral projection. As a result of the combination of the ramp and peripheral projection, a space-saving embodiment of the edge of the opening in the first component is achieved.

The edge of the opening of the first component is advantageously constructed so as to have a first peripheral projection which is engaged behind in the pre-assembly position by the snap-fit tongue of the connecting element. In an advantageous manner, alternatively or additionally, the edge of the opening of the first component is constructed so as to have a second peripheral projection, on which the engaging edge of the engaging tongue of the connecting element is supported in the pre-assembly position.

Other features which are considered as characteristic for the invention are set forth in the appended claims.

Although the invention is illustrated and described herein as embodied in a connecting element and connecting arrangement, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an exploded, perspective view of a connecting arrangement having a connecting element and a first and a second component of a motor vehicle according to the invention;

FIG. 2 is an exploded, perspective view of the connecting arrangement according to FIG. 1 from a different perspective;

FIG. 3 is a partially cut-away, perspective view of the connecting element according to FIG. 1 in an engaged pre-assembly position in the first component;

FIG. 4 is a partially cut-away, perspective view of the connecting element according to FIG. 1 in an engaged pre-assembly position in the first component from a different perspective with respect to FIG. 3;

FIG. 5 is a perspective view showing the connecting arrangement according to FIG. 1, wherein a fixing element pre-assembled on the first component is placed on the second component;

FIG. 6 is a perspective view showing the connecting arrangement in a pre-assembly position according to FIG. 5 from a different perspective;

FIG. 7 is a perspective view showing the connecting element of the connecting arrangement according to FIG. 1 in an angular position between the pre-assembly position and a final assembly position, wherein the first component is omitted from the drawing;

FIG. 8 is a perspective view showing the connecting arrangement according to FIG. 1 in a final assembly state in a view toward the connecting element which is guided by the second component and which is rotated into an angular end position; and

FIG. 9 is a schematic view of effective regions of a clamping wedge of a connecting element according to FIG. 1.

### DETAILED DESCRIPTION OF THE INVENTION

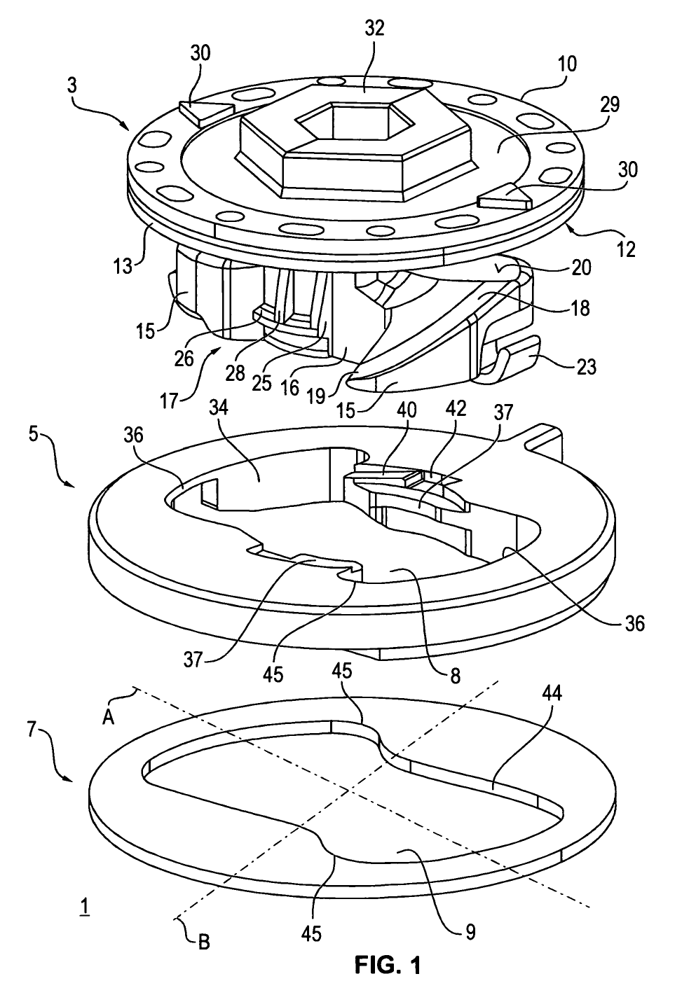

Referring now to the figures of the drawings in detail and first, particularly to FIG. 1 thereof, there is shown an exploded view of a connecting arrangement 1 which is used for the mechanical connection of two components of a motor vehicle, in particular two components of a motor vehicle door. The connecting arrangement 1 contains a connecting element 3 and a first component 5 and a second component 7. The first component 5 is mounted, for example, in a rotationally secure manner on a unit carrier, in particular on a door module. The second component 7 is, for example, part of an internal door plate.

The connecting element 3 contains an abutment collar 10 which is positioned on the first component 5 in an assembled state. There is arranged at a rear side 12 of the abutment collar 10 a peripheral seal 13 which further performs the function of a tolerance compensation member in addition to the functionality of a seal. Furthermore, two clamping wedges 15 which are arranged diametrically relative to each other are included by the connecting element 3 and are arranged on a central shaft portion 16 as components of a transverse bar 17 which extends in a longitudinal direction.

A planar sliding path 18 is arranged on the clamping wedges 15. The clamping wedges 15 having the sliding paths 18 taper in a peripheral direction into an introduction tip 19. A planar abutment face 20 is arranged at the end of each sliding path 18 adjacent to the rear side 12 of the abutment collar 10. In the final assembled state, the first component 5 and the second component 7 are retained with pretensioning between the abutment faces 20 and the abutment collar 10 of the connecting element 3. The restoring force required for the pretensioning is applied by the seal 13.

Furthermore, a snap-fit tongue 23 is arranged on each clamping wedge 15. The two snap-fit tongues 23 extend radially outward in a longitudinal direction of the transverse bar 17. The free ends of the snap-fit tongues 23 are angled away toward the rear side 12 of the abutment collar 10. There are further arranged on the shaft portion 16 two engaging tongues 25 which are arranged diametrically relative to each other and of which only one is visible. There is formed on the engaging tongues 25 an engaging edge 26 which is supported by two strut arrangements 28. The snap-fit tongues 23 and the engaging tongues 25 are each deformable radially inward with a restoring force being produced.

Two markings 30 are arranged at the upper side 29 of the abutment collar 10 of the connecting element 3. It is readily possible to observe the specific angular position of the connecting element 3 by the position of the markings 30. In particular, the connecting element 3 can be moved out of an angular insertion position by use of the markings 30 into a defined angular end position in which the components 5, 7 are retained in a state clamped to each other in a defined manner. The torque necessary for rotating the connecting element 3 can be produced at the abutment collar by a suitable tool via the internal hexagonal receiving member 32.

The two components 5, 7 have openings 8 and 9 which correspond to each other. Two first peripheral projections 36 are arranged diametrically relative to each other at the edge 34 of the opening 8 in the first component 5. Furthermore, two second peripheral projections 37 which are arranged diametrically relative to each other are formed at the edge 34 in a state substantially rotated through an angle of 90° relative thereto. A recessed ramp 40 which opens in an engaging groove 42 is formed on the second peripheral projections 37. The edge 44 of the opening in the second component 7 is constructed to be smooth and without functional elements.

The openings 8 and 9 which correspond to each other in the first component 5 and in the second component 7 each have a contour which is increased into a protrusion 45 in the radial edge region thereof for receiving the clamping wedge 15 in the rotational fixing direction in order to be able to introduce the introduction tip 19. The dimension of the openings 8, 9 in a longitudinal direction is such in this regard that the transverse bar 17 of the connecting element 3 can be guided through in the angular insertion position shown. When the connecting element 3 guided through the openings 8, 9 is rotated in a clockwise direction, the sliding paths 18 are rotated inward under the second component 7. As a result of the wedge-like form of the clamping wedges 15, there is produced an increasing clamping action of the two components 5, 7 against the abutment collar 10. In a final assembly position with a defined angular end position, the abutment faces 20 of the connecting element 3 adjoin the rear side of the second component 7 in a planar manner. The angular insertion position A and the angular end position B of the transverse bar 17 is indicated on the second component 7. The angular difference between the angular insertion position A and the angular end position B is approximately 100° in this instance.

In the position shown, the connecting element 3 is in the angular insertion position A. In this position, the connecting element 3 can be introduced into the opening 8 of the first component 5 until the engaging edges 26 of the engaging tongues 25 strike the respective second peripheral projections 37. At the same time, in this position the first peripheral projections 36 are engaged behind by the angled snap-fit tongues 23. A specifically defined pre-assembly position results from the cooperation between the snap-fit tongues 23 and the engaging tongues 25. Without any additional application of force, the connecting element 3 is retained in the opening 8 of the first component 5 in the pre-assembly position in a non-releasable manner with the transverse bar 17 thereof. In this position, the connecting element 3 and the first component 5 form a delivery state.

In order to assemble the first component 5 with the second component 7 with the connecting element 3 which is fixed thereto in a non-releasable manner in the pre-assembly position, the connecting element 3 is axially displaced after the openings 8, 9 have been brought into a superimposed alignment position, wherein the engaging tongues 25 are each deformed radially inward. The axial offset of the connecting element 3 is substantially brought about by rotation, wherein the introduction tips 19 of the respective clamping wedges 15 are inwardly rotated under the second component 7. A large travel of the connecting element 3 is obtained with a small gradient by means of the sliding path 18 which is long in a peripheral direction and which extends in the present case over an angular range of approximately 70°. As a result of the planar sliding path 18, effects involving shavings or jamming at the edge 44 of the second component 7 are avoided. Generally, the axial travel of the connecting element 3 can be achieved by a rotational movement, for which only a small torque is necessary. The effective region of the introduction tip 19, in which no clamping is yet brought about, extends over an angular range of approximately 8°. The planar abutment face 20 covers an angular range of approximately 30°.

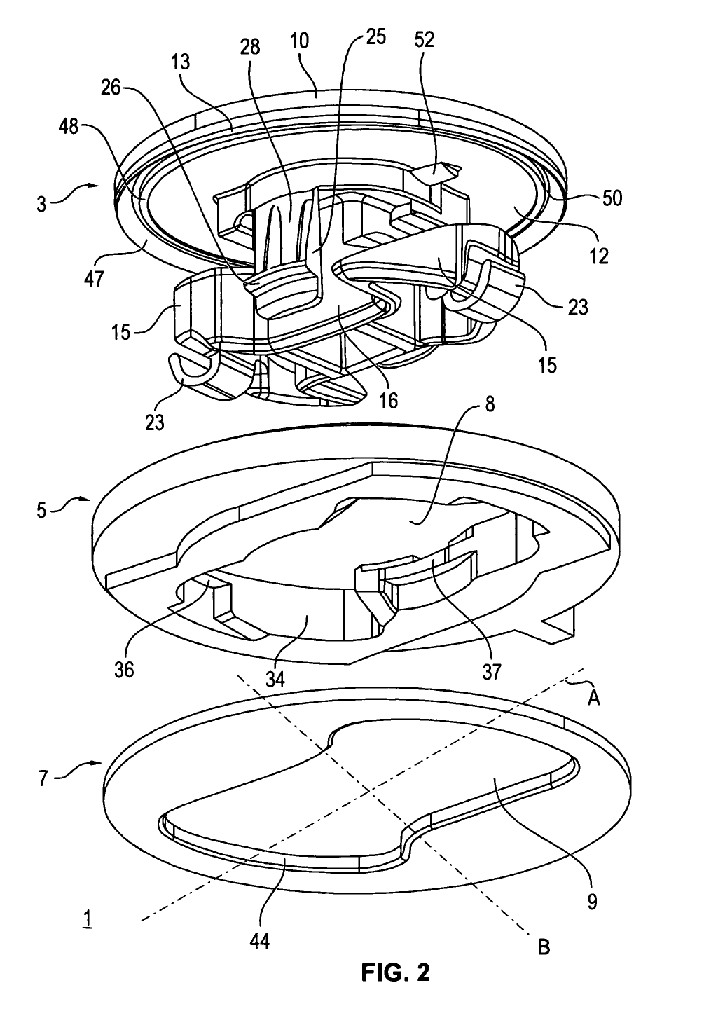

As can be seen in FIG. 2, the connecting element 3 is rotated in order to reach the final assembly position until an engaging wedge 52 at the rear side 12 of the abutment collar 10 moves into engagement with the engaging groove 42 in the second peripheral projection 37 of the first component 5. In this case, the engaging wedge 52 moves at least during a partial range of the rotational movement over the recessed ramp 40. In the engaged state, the connecting element 3 has reached a defined angular end position B in which the two components 5, 7 are securely retained on each other or clamped with a defined pretensioning. As a result of the markings 30, it is readily possible to identify from the outer side whether the respective connecting elements 3 are in the angular end position B thereof, which is also advantageous for subsequent control.

In FIG. 2, the specific construction of the seal 13 can be seen at the rear side 12 of the abutment collar 10. The seal 13 contains an outer flexible sealing lip 47 and an inner, axially recessed contact lip 48. The sealing lip 47 and contact lip 48 are separated from each other by a channel 50. The sealing lip 47 is constructed to be comparatively thin and can in this regard flexibly conform to the surface of the first component 5. The resilient pretensioning of the components relative to each other is achieved via the contact lip 48 with the tolerances being compensated for at the same time.

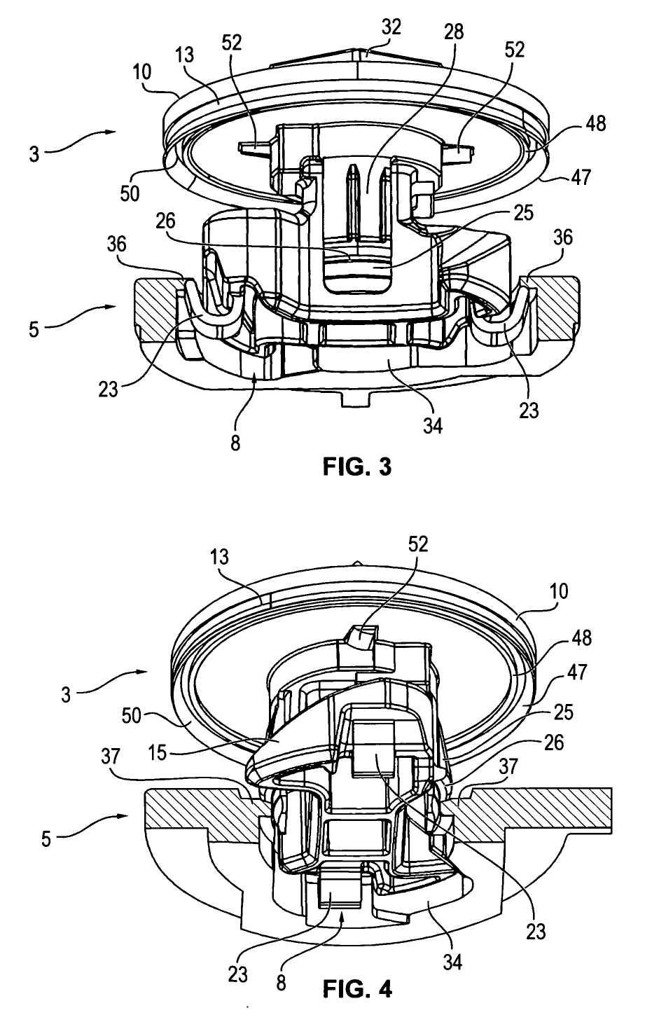

FIG. 3 is a partially cut-away view of the connecting element 3 in the pre-assembly position thereof in the opening 8 of the first component 5. It can clearly be seen how the snap-fit tongues 23 which face the abutment collar 10 with the free ends thereof are supported on the edge 34 at the rear side of the first peripheral projections 36.

FIG. 4 shows the pre-assembly position of the connecting element 3 on the first component 5 as a perspective view rotated through 90°. In this instance, it can be seen how the engaging tongues 25 are supported with the respective engaging edge 26 in the pre-assembly position on the second peripheral projections 37 at the edge 34 of the opening 8 in the first component 5. It is possible to press the connecting element 3 further into the opening 8 of the first component 5 only with increased application of force with the engaging tongues 25 being bent inward.

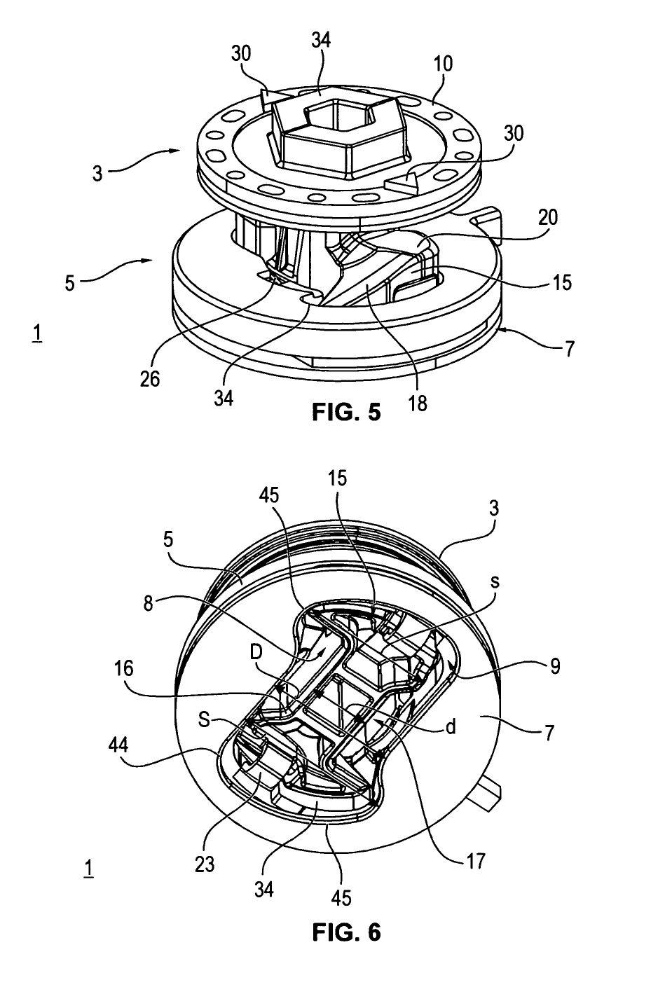

In FIG. 5, the functional unit which can be seen in the pre-assembly position from FIGS. 3 and 4 and which contains the connecting element 3 and the first component 5 is placed on a second component 7 for final assembly, wherein the two openings 8, 9 of the first component 5 and the second component 7 are aligned with each other, respectively. FIG. 6 illustrates that assembly position when viewed through the opening 9 of the second component 7. From this point of view, it can also be seen that the width s of a clamping wedge 15, which width extends in the rotational plane and is perpendicular to the transverse bar 17, has a greater dimension than the thickness d of the shaft region 16. As a result of the protrusion 45, the clear width S of the contour of the opening 8 in the second component 7 in the radial edge region is greater than the clear width D in the central region.

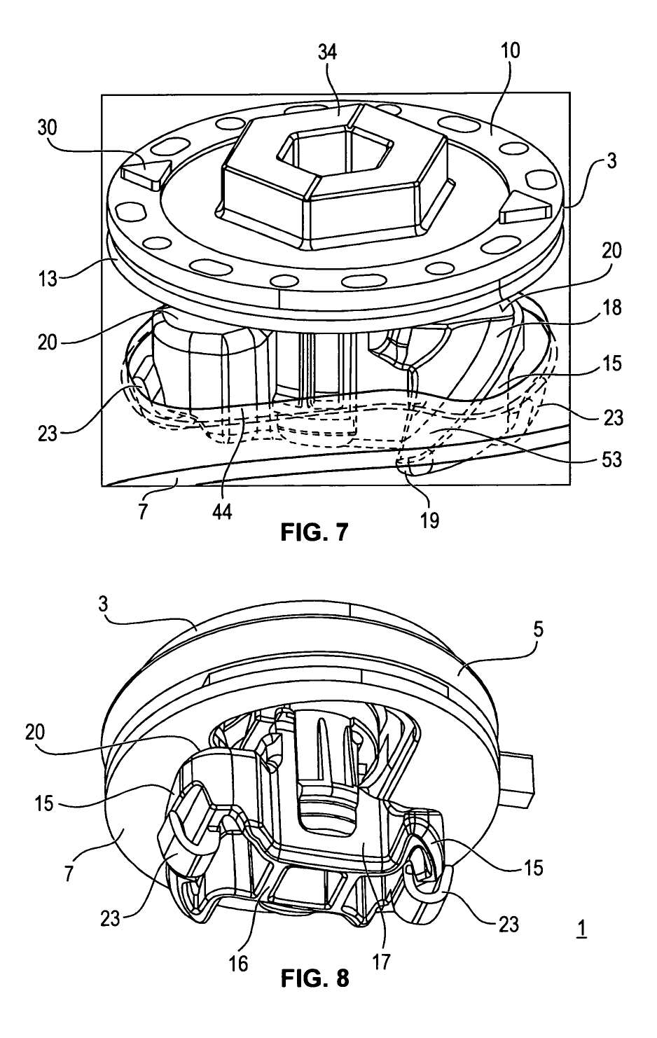

For final assembly, the connecting element 3 is subsequently rotated in the clockwise direction. In this instance, the introduction tips 19 of the clamping wedges 15 each move under the edge 44 at the opening 9 of the second component 7. This state is illustrated in FIG. 7 with the first component 5 being omitted from the drawing. The introduction tip 19 is already introduced under the second component 7 in the position shown.

A linear contact location or a linear support 53 is produced between the sliding path 18 and the edge 44 at the opening 9 of the second component 7. A shaving or tilting action at the contact location between the clamping wedges 15 and the edge 44 is thereby prevented when the connecting element 3 is rotated inward.

FIG. 8 illustrates the connecting arrangement 1 in the final assembly position when viewed toward the introduced transverse bar 17 of the connecting element 3. In the final assembly position, the transverse bar 17 has reached an angular end position which is rotated through 100° with respect to the angular insertion position in the pre-assembly position. FIG. 8 shows that the respective abutment faces 20 on the transverse bar 17 or the clamping wedges 15 are now supported against the rear side of the second component 7.

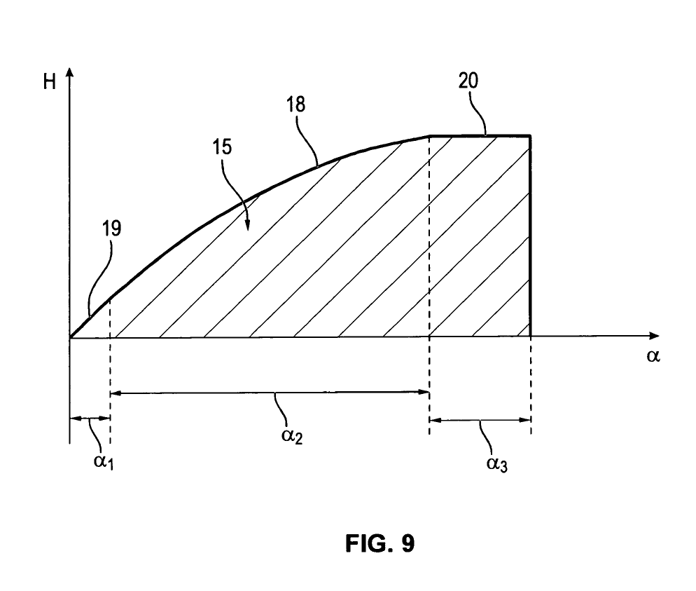

FIG. 9 again illustrates the effective regions of the clamping wedge 15 in a schematic manner. The planar sliding path 18 extends from the introduction tip 19 as far as the planar abutment face 20. Generally, the wedge-like construction can clearly be seen. The covered angular ranges a are indicated on the abscissa. The correspondingly resultant travel H can be read from the ordinate.

The effective range of the introduction tip 19, in which no clamping takes place yet, covers an angular range of α1 between 5° and 10°. The region between the introduction tip 19 and the abutment face 20 extends over an angular range α2 between 60° and 75°. The angular range α3 of the abutment face extends over from 25° to 30°. A covered angular range between 95° and 115° is preferably produced overall for the rotation of the connecting element or the clamping wedge between the angular insertion position and the angular end position.

The following is a summary list of reference numerals and the corresponding structure used in the above description of the invention:
1 Connecting arrangement
3 Connecting element
5 First component
7 Second component
8 Opening of first component
9 Opening of second component
10 Abutment collar
12 Rear side
13 Seal
15 Clamping wedge
16 Shaft portion
17 Transverse bar
18 Sliding path
19 Introduction tip
20 Abutment face
23 Snap-fit tongue
25 Engaging tongue
26 Engaging edge
28 Strut arrangement
29 Upper side
30 Marking
32 Internal hexagonal receiving member
34 Edge
36 First peripheral projection
37 Second peripheral projection
40 Ramp
42 Engaging groove
44 Edge
45 Protrusion
47 Sealing lip
48 Contact lip
50 Channel
52 Engaging wedge
53 Linear support
A Angular insertion position
B Angular end position
D Wide contour
S Wide contour
H Travel
s Wide clamping wedge
d Thick shaft portion
α Angular ranges

1. A connector, comprising:
at least a first component and a second component for a motor vehicle each having mutually corresponding openings formed therein; and
a connecting element containing an abutment collar for abutment against said first component and a transverse bar substantially extending in a longitudinal direction and having at least one clamping wedge for clamping said second component against said first component in a rotated final assembly position, said connecting element further containing a shaft portion carrying said transverse bar for being rotatably introduced through said corresponding openings in said first component and in said second component, wherein, in order to produce a connection in the rotated final assembly position, said connecting element can be rotated from an angular insertion position into an angular end position, in which said connecting element engages through said corresponding openings of said first component and said second component, said clamping wedge having a planar sliding path forming a linear abutment against an edge of said corresponding opening of said second component at least over a partial range of a rotational movement into the rotated final assembly position.

2. The connector according to claim 1, wherein:
said abutment collar has a rear side with an engaging wedge; and
said first component has a recessed ramp formed therein and disposed at an edge of said corresponding opening of said first component, said recessed ramp provided for abutment of said engaging wedge at said rear side of said abutment collar at least over a partial range of the rotational movement into the rotated final assembly position.

3. The connector according to claim 2, wherein said first component has an engaging groove formed therein and said recessed ramp merges into said engaging groove in which said engaging wedge is engaged in the rotated final assembly position of said connecting element.

4. The connector according to claim 2, wherein said first component has a second peripheral projection and said recessed ramp is disposed on said second peripheral projection.

5. The connector according to claim 2, wherein said connecting element has a snap-fit tongue and said edge of said corresponding opening of said first component is constructed so as to have a first peripheral projection which is engaged behind in a pre-assembly position by said snap-fit tongue.

6. The connector according to claim 2, wherein said connecting element has an engaging tongue with an engaging edge, said edge of said corresponding opening of said first component is constructed so as to have a second peripheral projection, on which said engaging edge of said engaging tongue of said connecting element is supported in a pre-assembly position.

7. The connector according to claim 1, wherein said clamping wedge has a width extending in a rotational plane and is perpendicular to the longitudinal direction of said transverse bar and has a larger dimension than a corresponding thickness of said shaft portion, and a contour of said corresponding opening of said second component is increased into a protrusion in a radial edge region thereof in order to receive said clamping wedge in a rotational direction relative to the rotated final assembly position, wherein a clear width of said contour in the radial edge region of said protrusion has a greater dimension than a clear width of said contour in a central region in order to receive said shaft portion.

8. A connector, comprising:
at least a first component and a second component of a motor vehicle having mutually corresponding openings formed therein; and
a connecting element containing an abutment collar for abutment against said first component and a transverse bar substantially extending in a longitudinal direction and having at least one clamping wedge for clamping said second component against said first component in a rotated final assembly position, said connecting element further having a shaft portion carrying said transverse bar for being rotatably introduced through said corresponding openings in said first component and in said second component, wherein, in order to produce a connection in the rotated final assembly position, said connecting element can be rotated from an angular insertion position into an angular end position, in which said connecting element engages through said corresponding openings of said first component and said second component, said clamping wedge having a width extending in a rotational plane and is perpendicular to the longitudinal direction of said transverse bar and having a larger dimension than a corresponding thickness of said shaft portion, and a contour of said corresponding opening of said second component is increased into a protrusion in a radial edge region thereof in order to receive said clamping wedge in a rotational direction relative to the rotated final assembly position, wherein a clear width of said contour in the radial edge region of said protrusion has a greater dimension than a clear width of said contour in a central region in order to receive said shaft portion.

9. The connector according to claim 8, wherein an angular range which is covered by said contour of said corresponding opening of said second component in said radial edge region in a peripheral direction is between 95° and 115°.

10. The connector according to claim 8, wherein:
said abutment collar has a rear side with an engaging wedge; and
said first component has a recessed ramp formed therein and disposed at an edge of said corresponding opening of said first component, said recessed ramp provided for abutment of said engaging wedge at said rear side of said abutment collar at least over a partial range of a rotational movement into the final assembly position.

11. The connector according to claim 10, wherein said first component has an engaging groove formed therein and said recessed ramp merges into said engaging groove in which said engaging wedge is engaged in the rotated final assembly position of said connecting element.

12. The connector according to claim 10, wherein said first component has a second peripheral projection and said recessed ramp is disposed on said second peripheral projection.

13. The connector according to claim 10, wherein said connecting element has a snap-fit tongue and said edge of said corresponding opening of said first component is constructed so as to have a first peripheral projection which is engaged behind in a pre-assembly position by said snap-fit tongue.

14. The connector according to claim 10, wherein said connecting element has an engaging tongue with an engaging edge, said edge of said corresponding opening of said first component is constructed so as to have a second peripheral projection, on which said engaging edge of said engaging tongue of said connecting element is supported in a pre-assembly position.

15. The connector according to claim 8, wherein said clamping wedge has a planar sliding path forming a linear abutment against an edge of said corresponding opening of said second component at least over a partial range of the rotational movement into the rotated final assembly position.

16. A connecting element for use in a connector for a mechanical connection of two components of a motor vehicle, the connecting element comprising:
an abutment collar for abutment against a first component;
a transverse bar substantially extending in a longitudinal direction and having at least one clamping wedge for clamping a second component against the first component in a rotated final assembly position;
a shaft portion carrying said transverse bar for being rotatably introduced through corresponding openings in the first component and in the second component; and
said clamping wedge containing a planar sliding path constructed to form a linear abutment against an edge of the corresponding opening in the second component at least over a partial range of a rotational movement into the rotated final assembly position.

17. The connecting element according to claim 16, wherein said clamping wedge tapers into a finger-shaped introduction tip and, at another end thereof, contains a planar abutment face, into which said planar sliding path merges where applicable.

18. The connecting element according to claim 17, wherein:
said finger-shaped introduction tip extends over an angular range between 5° and 10°;
said planar sliding path extends over an angular range between 65° and 85°; and
said planar abutment face extends over an angular range between 25° and 30°.

19. The connecting element according to claim 16, wherein said clamping wedge extends in a peripheral direction over an angular range between 95° and 115°.

20. The connecting element according to claim 16, further comprising means for pre-positioning said transverse bar in the corresponding opening of the first component in a pre-assembly position.

21. The connecting element according to claim 16, further comprising at least one radially outwardly extending snap-fit tongue disposed in a region of said clamping wedge and functioning as said means for pre-positioning.

22. The connecting element according to claim 21, wherein said snap-fit tongue having a free end angled away in a direction of said abutment collar and is constructed in order to engage behind a first peripheral projection at an edge of the corresponding opening of the first component in a pre-assembly position.

23. The connecting element according to claim 20, wherein said means for pre-positioning said transverse bar in a region of said shaft portion contains at least one engaging tongue having an engagement edge for abutment against a second peripheral projection at an edge of the corresponding opening of the first component in the pre-assembly position.

24. The connecting element according to claim 23, wherein said engagement edge is supported on said engaging tongue at a side facing said abutment collar with a wedge-shaped strut.

25. The connecting element according to claim 16, wherein said abutment collar contains a rear side facing said shaft portion and having an engaging wedge, said engaging wedge provided for engaging in an engaging groove of the first component in the rotated final assembly position.

26. The connecting element according to claim 16, further comprising a seal having a flexible sealing lip and a contact lip which is axially recessed relative thereto and disposed at a rear side of said abutment collar facing said shaft portion.

27. The connecting element according to claim 16, wherein said clamping wedge has a width, said width extends in a rotational plane and is perpendicular to the longitudinal direction of said transverse bar, said width has a larger dimension than a corresponding thickness of said shaft portion.

28. A connecting element for use in a connector for a mechanical connection of two components of a motor vehicle, the connecting element comprising:
an abutment collar for abutment against a first component;
a transverse bar substantially extending in a longitudinal direction and having at least one clamping wedge for clamping a second component against the first component in a rotated final assembly position;
a shaft portion carrying said transverse bar for being rotatably introduced through corresponding openings in the first component and in the second component; and
said clamping wedge having a width, said width extending in a rotational plane and is perpendicular to the longitudinal direction of said transverse bar, said width having a larger dimension than a corresponding thickness of said shaft portion.

29. The connecting element according to claim 28, wherein said clamping wedge tapers into a finger-shaped introduction tip and, at another end thereof, contains a planar abutment face.

30. The connecting element according to claim 29, wherein:
said finger-shaped introduction tip extends over an angular range between 5° and 10°; and
said planar abutment face extends over an angular range between 25° and 30°.

31. The connecting element according to claim 28, wherein said clamping wedge extends in a peripheral direction over an angular range between 95° and 115°.

32. The connecting element according to claim 28, further comprising means for pre-positioning said transverse bar in the corresponding opening of the first component in a pre-assembly position.

33. The connecting element according to claim 32, further comprising at least one radially outwardly extending snap-fit tongue disposed in a region of said clamping wedge and functioning as said means for pre-positioning.

34. The connecting element according to claim 33, wherein said snap-fit tongue having a free end angled away in a direction of said abutment collar and is constructed in order to engage behind a first peripheral projection at an edge of the corresponding opening of the first component in the pre-assembly position.

35. The connecting element according to claim 32, wherein said means for pre-positioning said transverse bar in said region of said shaft portion is at least one engaging tongue having an engagement edge for abutment against a second peripheral projection at an edge of the corresponding opening of the first component in the pre-assembly position.

36. The connecting element according to claim 35, wherein said engagement edge is supported on said engaging tongue at a side facing said abutment collar with a wedge-shaped strut.

37. The connecting element according to claim 28, wherein said abutment collar contains a rear side facing said shaft portion and having an engaging wedge, said engaging wedge provided for engaging in an engaging groove of the first component in the rotated final assembly position.

38. The connecting element according to claim 28, further comprising a seal having a flexible sealing lip and a contact lip which is axially recessed relative thereto and disposed at a rear side of said abutment collar facing said shaft portion.

39. The connecting element according to claim 28, wherein said clamping wedge containing a planar sliding path constructed to form a linear abutment against an edge of the corresponding opening in the second component at least over a partial range of a rotational movement into the rotated final assembly position.
